(19) United States
(12) Patent Application Publication
(10) Pub. No.: US 2019/0369354 A1
(43) Pub. Date: Dec. 5, 2019

(54) LENS APPARATUS, IMAGING APPARATUS, AND IMAGING SYSTEM

(71) Applicant: CANON KABUSHIKI KAISHA, Tokyo (JP)

(72) Inventor: Hideomi Nakagami, Utsunomiya-shi (JP)

(21) Appl. No.: 16/423,704

(22) Filed: May 28, 2019

(30) Foreign Application Priority Data
May 29, 2018 (JP) 2018-102836

(51) Int. Cl. G02B 7/04; H04N 5/225; G02B 7/02; H04N 5/232; G02B 15/15

(52) U.S. Cl. CPC G02B 7/04; H04N 5/2254; G02B 15/155; H04N 5/23296; G02B 7/022

(57) ABSTRACT

A lens apparatus includes an optical system including a zoom lens unit, a diaphragm configured to adjust a light amount in the optical system, a position detector configured to detect a position of the zoom lens unit, and a controller configured to control an aperture amount of the diaphragm based on the position of the zoom lens unit. The controller selects, based on the position of the zoom lens unit detected by the position detector, part of data from data indicating a relationship between a target F-number of the diaphragm and driving instruction information when the zoom lens unit is located at a predetermined position, and controls the aperture amount of the diaphragm using the part of the data.

### BACKGROUND OF THE INVENTION

### Field of the Invention

The present invention relates generally to a lens apparatus having a diaphragm (aperture stop), and more particularly to a lens apparatus suitable for use with a lens interchangeable type digital single-lens reflex camera, a digital still camera, a digital video camera, a lens interchangeable digital video camera, and the like.

### Description of the Related Art

As a focal length of an optical system including a zoom lens unit changes, an F-number (aperture value) changes even if a diaphragm has the same aperture diameter. Japanese Patent No. (“JP”) 5984489 discloses a lens apparatus that stores a driving instruction value that minimizes an error between a target F-number and an actual F-number and controls the aperture diameter of the diaphragm.

The lens apparatus disclosed in JP 5984489 controls the aperture diameter of the diaphragm with high accuracy. The lens apparatus disclosed in JP 5984489 applied to a zoom lens needs to store data indicating a relationship between a target F-number and a driving instruction value for each zoom position. As a result, the data capacity increases.

### SUMMARY OF THE INVENTION

The present invention provides a lens apparatus, an imaging apparatus, and an imaging system, each of which can accurately control a diaphragm with a small data capacity.

A lens apparatus according to one aspect of the present invention includes an optical system including a zoom lens unit, a diaphragm configured to adjust a light amount in the optical system, a position detector configured to detect a position of the zoom lens unit, and a controller configured to control an aperture amount of the diaphragm based on the position of the zoom lens unit. The controller selects, based on the position of the zoom lens unit detected by the position detector, part of data from data indicating a relationship between a target F-number of the diaphragm and driving instruction information when the zoom lens unit is located at a predetermined position, and controls the aperture amount of the diaphragm using the part of the data.

An imaging apparatus according to another aspect of the present invention to which a lens apparatus including a zoom lens unit and a diaphragm is detachably attached includes a communicator configured to transmit information on a target F-number of the diaphragm, and a controller configured to control the communicator. The lens apparatus selects, based on a position of the zoom lens unit detected by a position detector, part of data indicating a relationship between a target F-number of the diaphragm and driving instruction information when the zoom lens unit is located at a predetermined position, and controls an aperture amount of the diaphragm using the part of the data.

An imaging system according to another aspect of the present invention includes the above lens apparatus, and an imaging apparatus including an image sensor configured to photoelectrically convert an optical image formed through the lens apparatus.

Further features of the present invention will become apparent from the following description of exemplary embodiments with reference to the attached drawings.

### BRIEF DESCRIPTION OF THE DRAWINGS

FIG. 1 is a block diagram of an imaging system according to a first embodiment.

FIG. 2 is illustrative data stored in a driving instruction value memory according to the first embodiment.

FIG. 3 is a graph showing an error before and after the driving instruction value is corrected according to the first embodiment.

FIG. 4 is illustrative data stored in a read position memory according to the first embodiment.

FIG. 5 is an explanatory view of a measurement range according to the first embodiment.

FIG. 6 is a graph showing an error before and after the read position is corrected according to the first embodiment.

FIG. 7 illustrates illustrative data stored in a driving instruction value memory according to a second embodiment.

FIG. 8 illustrates illustrative data stored in a read position memory according to the second embodiment.

FIG. 9 illustrates illustrative data stored in a driving instruction value memory according to a third embodiment.

FIG. 10 illustrates illustrative data stored in a read position memory according to the third embodiment.

FIG. 11 illustrates illustrative data stored in a driving instruction value memory as a variation of the third embodiment.

FIG. 12 illustrates illustrative data stored in a read position memory as the variation of the third embodiment.

### DESCRIPTION OF THE EMBODIMENTS

Referring now to the accompanying drawings, a detailed description will be given of embodiments of the present invention.

### First Embodiment

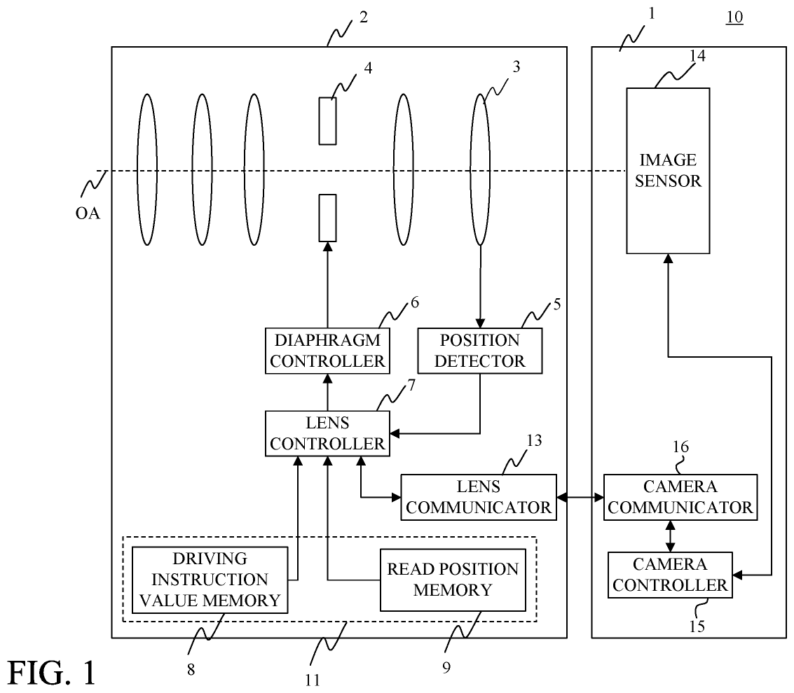

Referring now to FIG. 1, a description will be given of a configuration of an imaging system according to a first embodiment of the present invention. FIG. 1 is a block diagram of an imaging system 10. The imaging system 10 includes a camera body (an imaging apparatus such as a single-lens reflex camera) 1 and an interchangeable lens (lens apparatus) 2 that is attachable to and detachable from the camera body 1.

The interchangeable lens 2 includes an optical system (imaging optical system) including a zoom lens unit 3 and a diaphragm (aperture stop) 4. A position detector 5 detects the position of the zoom lens unit 3 in a direction along the optical axis OA (optical axis direction). The diaphragm 4 has a plurality of unillustrated diaphragm blades, and an unillustrated opening and closing mechanism for opening and closing the plurality of diaphragm blades. The opening and closing mechanism in the diaphragm 4 is driven by a diaphragm driver 6.

The diaphragm 4 is a so-called iris diaphragm that forms a diaphragm aperture on the optical axis as a result of that parts of a plurality of blades arranged around the optical axis OA overlap one another. An F-number (aperture value) increases or decreases according to the positions of the plurality of diaphragm blades. An overlap amount of the plurality of diaphragm blades varies and the operational load applied to the diaphragm driver 6 varies according to the positions of the plurality of diaphragm blades. In general, as the F-number or the overlap amount among a plurality of diaphragm blades increases, the operational load increases.

The diaphragm driver 6 includes a stepping motor, and is controlled by a lens controller 7. More specifically, the lens controller 7 controls the driving direction of the diaphragm driver 6 by changing the polarity of a diaphragm driving signal applied to the diaphragm driver 6, and by increasing or decreasing the number of pulses of the diaphragm driving signal. Thereby, the opening and closing amount (aperture amount) of the plurality of diaphragm blades in the diaphragm 4 can be controlled.

The diaphragm 4 includes an unillustrated diaphragm position detector as an actual F-number measurement unit that detects the positions of a plurality of aperture blades corresponding to the open F-number (open aperture value). The diaphragm position detector is provided in consideration of an impact or the like, but may be used for the open control based on the pulse count of the stepping motor.

Thus, the lens controller 7 controls the aperture amount of the diaphragm 4 based on the signal (target F-number signal) received from the camera body 1 and the position of the zoom lens unit 3 detected by the position detector 5 via the lens communicator (communicator) 13. At this time, the lens controller 7 uses data stored in a memory 11. The memory 11 includes a driving instruction value memory 8 and a read position memory 9. The driving instruction value memory 8 stores data indicating a relationship between the target F-number of the diaphragm 4 and the driving instruction information when the zoom lens unit 3 is located at the telephoto end position (predetermined position). In this embodiment, the predetermined position is the telephoto end position, but the present invention is not limited to this embodiment and may be another position such as the wide-angle end position. The read position memory 9 stores the read position (read position of data stored in the driving instruction value memory 8) for each position of the zoom lens unit 3 detected by the position detector 5.

In other words, the lens controller 7 selects part of data (data of the range determined by the read position stored in the read position memory 9) stored in the driving instruction value memory 8 based on the position of the zoom lens unit 3 detected by the position detector 5. The lens controller 7 controls the aperture amount of the diaphragm 4 using the selected part of the data.

The interchangeable lens 2 includes the memory 11 (the driving instruction value memory 8 and the read position memory 9) that stores each data in this embodiment, but the present invention is not limited to this embodiment. At least part of the data stored in the memory 11 may be stored in a device other than the interchangeable lens 2 such as a cloud computing system. The lens controller 7 can control the aperture amount of the diaphragm 4 by receiving necessary data by a wireless communication or the like.

The camera body 1 includes an image sensor 14, a camera controller 15, and a camera communicator 16. The image sensor 14 has a CMOS sensor or a CCD sensor, and photoelectrically converts an optical image (object image) formed through an optical system (imaging optical system) in the interchangeable lens 2 into output image data. The camera controller 15 controls the image sensor 14 and the camera communicator 16. The camera controller 15 transmits the target F-number to the lens controller 7 via the camera communicator 16 and the lens communicator 13. The camera communicator 16 is a communicator that transmits information on the target F-number of the diaphragm 4 to the interchangeable lens 2.

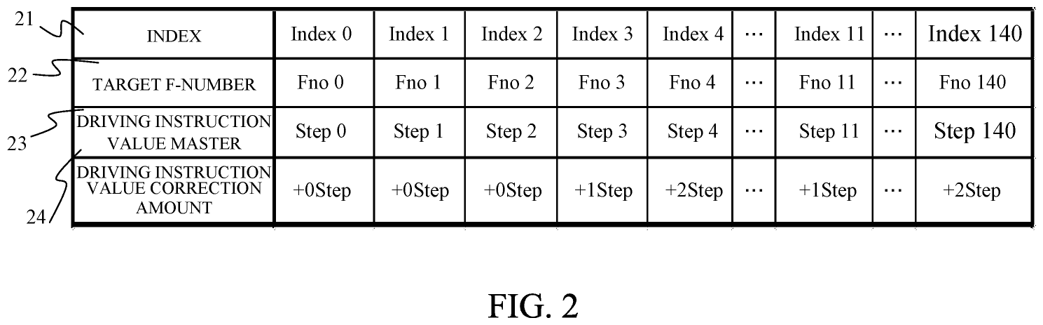

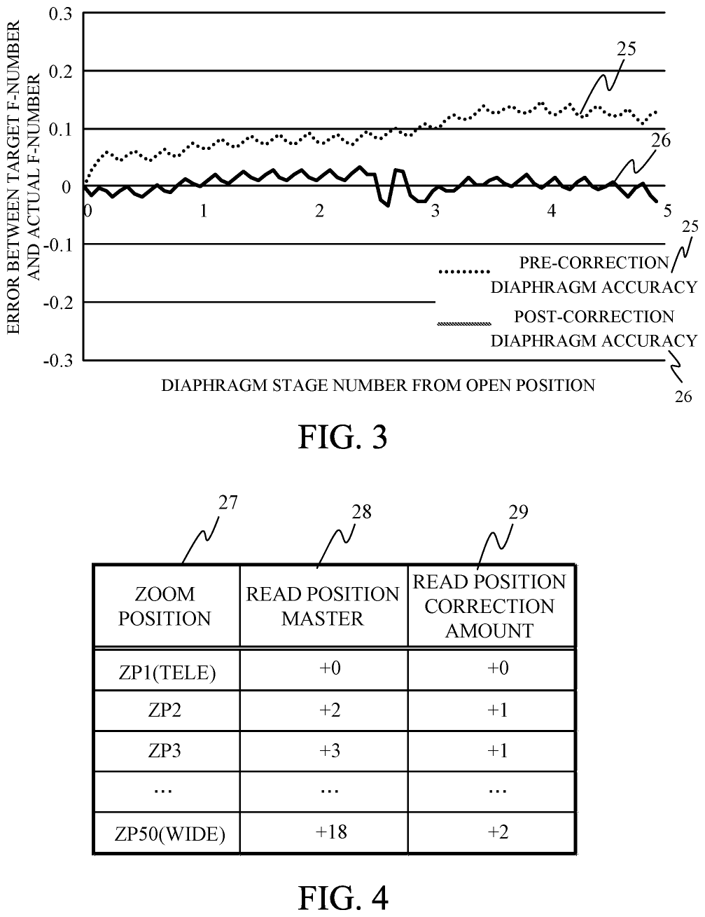

Referring now to FIGS. 2 and 3, a description will be given of data stored in the driving instruction value memory 8 according to this embodiment. FIG. 2 illustrates illustrative data stored in the driving instruction value memory 8 or the data representative of the relationship between the target F-number of the diaphragm 4 and the driving instruction information when the zoom lens unit 3 is located at the telephoto end position (TELE state).

In FIG. 2, the driving instruction value memory 8 stores three types of data or a target F-number 22, a driving instruction value master 23, and a driving instruction value correction amount 24 for each 1-2 phase stop position. In this embodiment, the driving instruction information includes the driving instruction value master 23 and the driving instruction value correction amount 24. An index 21 is a column direction number of table data, is only shown for explanation, and is not stored in the driving instruction value memory 8.

The target F-number 22 is a target F-number at each 1-2 phase stop position. The driving instruction value master 23 is a design value (optical design value) of the driving instruction value. The drive command value master 23 is set for each 1-2 phase stop position. Herein, when the diaphragm driver 6 is driven based on the target F-number 22 and the driving instruction value master 23, the actual F-number may cause an error relative to the target F-number 22. The driving instruction value correction amount 24 is a correction amount for correcting the error between the actual F-number and the target F-number 22 (error of the driving instruction value). For example, when the target F-number 22 is Fno3, the index 21 is Index3, the driving instruction value master 23 is Step3, and the driving instruction value correction amount 24 is +1 Step. Thus, the driving instruction value when the target F-number 22 is Fno3 is Step3+1=Step4, and the lens controller 7 drives the aperture driver 6 to the position of Step4.

FIG. 3 is a graph showing an error between the target F-number 22 and the actual F-number before and after the driving instruction value is corrected. In FIG. 3, an ordinate axis represents an error between the target F-number 22 and the actual F-number, and the abscissa axis represents a diaphragm stage number from the open position of the diaphragm 4. In FIG. 3, the pre-correction diaphragm accuracy is indicated by a dotted line 25, and the post-correction diaphragm accuracy is indicated by a solid line 26.

The pre-correction diaphragm accuracy indicated by the dotted line 25 is the diaphragm accuracy when the driving instruction value is not corrected, and corresponds to the error between the actual F-number and the target F-number 22 when the diaphragm is driven with the value of the driving instruction value master 23. The post-correction diaphragm accuracy illustrated by the solid line 26 is the diaphragm accuracy of the diaphragm driven when the driving instruction value is corrected using the driving instruction value correction amount 24. In other words, the post-correction diaphragm accuracy corresponds to the error between the actual F-number and the target F-number 22 when the diaphragm is driven using the driving instruction value obtained by summing up the driving instruction value master 23 and the driving instruction value correction amount 24. Hence, the error between the target F-number 22 and the actual F-number can be reduced by correcting the driving instruction value based on the driving instruction value master 23.

Referring now to FIG. 4, a description will be given of the data stored in the read position memory 9 according to this embodiment. FIG. 4 illustrates illustrative data stored in the read position memory 9 or data read position (reference position) to be selected based on the position (zoom position) of the zoom lens unit 3 detected by the position detector 5 among data illustrated in FIG. 2. The lens controller 7 reads the data illustrated in FIG. 2 out of the read position (index 21 corresponding to the read position illustrated in FIG. 4) indicated by the data illustrated in FIG. 4.

In FIG. 4, the read position memory 9 stores three types of data or a zoom position 27, a read position master 28, and a read position correction amount 29. The zoom position 27 is the position of the zoom lens unit 3 detected by the position detector 5. As the zoom lens unit 3 moves and the focal distance changes, the F-number changes even if the aperture diameter (aperture amount) of the diaphragm 4 does not change. In other words, in order to maintain the same F-number when the focal length changes, it is necessary to change the aperture diameter in accordance with the focal length.

The read position master 28 is a design value (optical design value) regarding a shift amount of the read position of the data stored in the driving instruction value memory 8 at each zoom position 27. The read position correction amount 29 is a correction amount from the design value of the read position master 28. More specifically, for example, when the zoom position 27 is ZP1 (TELE), the sum of the read position master 28 and the read position correction amount 29 is +0. Then, the read position corresponding to the sum of the driving instruction value master 23 and the driving instruction value correction amount 24 for the target F-number 22 is not changed. In other words, when the target F-number 22 is Fno2, the driving instruction value master 23 and the driving instruction value correction amount 24 have values corresponding to the position where the index 21 is Index2, and the driving instruction value corresponding to Step 2+0=Step 2 is output.

On the other hand, when the zoom position 27 is ZP2, the sum of the read position master 28 and the read position correction amount 29 is 2+1=+3. Then, the read positions of the driving instruction value master 23 and the driving instruction value correction amount 24 are shifted by +3 for the target F-number 22. In other words, when the target F-number 22 is Fno2, the driving instruction value master 23 and the driving instruction value correction amount 24 have values corresponding to the position where the index 21 is Index4, and the driving instruction value corresponding to Step4+2=Step6 is output.

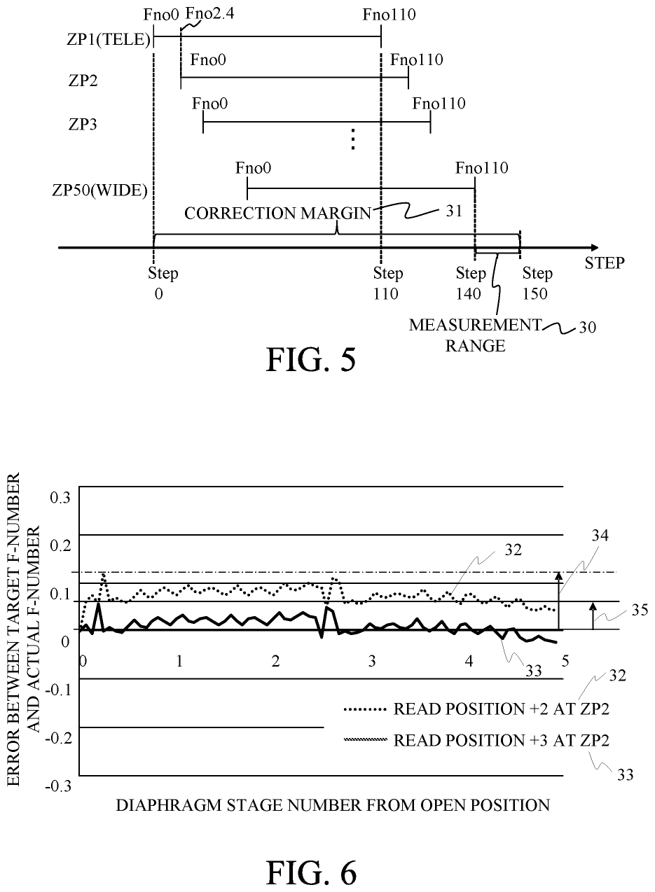

Referring now to FIGS. 5 and 6, a description will be given of a method of setting the driving instruction value correction amount 24 and the read position correction amount 29. FIG. 5 is an explanatory diagram of a measurement range, and illustrates a relationship between the F-number for each zoom position 27 and the driving instruction value.

First, when the zoom position 27 is ZP1 (TELE), the F-number is measured for each 1-2 phase drive stop position in a measurement range 31 (Step 0 to 150). The measurement range 31 is calculated by adding a correction margin 30 (Steps 140 to 150 in FIG. 5) to a range from the maximum opening (Step 0 in FIG. 5) to the minimum closing (Step 140 in FIG. 5). The range of the correction margin 30 is a range in which the measurement is performed to set the driving instruction value correction amount 24 near the closing (aperture). Hence, the range of the correction margin 30 is a target to be measured, but is not stored in the drive command value memory 8. A method of measuring an F-number contains a method of measuring a pupil diameter of a lens, a method of measuring a light amount after the light passes through a lens, and the like. From the measurement result, the driving instruction value correction amount 24 is set so that the target F-number 22 and the actual F-number are closest to each other.

Next follows a description of a method of setting the read position correction amount 29 when the zoom position 27 is ZP2. As illustrated in FIG. 5, the F-number at ZP1 (TELE) is Fno2.4 in which the F-number at ZP2 has the same diameter as that of Fno0. When the read position is +2, the driving instruction value at Fno0 is Index2 as Index 21, and the sum of the driving instruction value master 23 and the driving instruction value correction amount 24 is Step 2. Now assume that ΔFno0(ZP2) means an error between the actual F-number with Step 2 obtained in the above measurement and the target F-number Fno2.4 obtained by converting the diameter of Fno0 at ZP2 into a ZP1 equivalent. Similarly, ΔFno1 (ZP2), ΔFno2(ZP2), . . . , ΔFno110(ZP2) are obtained.

FIG. 6 is a graph showing an error between the target F-number 22 and the actual F-number before and after the read position is corrected. In FIG. 6, the ordinate axis represents the error between the target F-number and the actual F-number converted to ZP1, and the abscissa axis represents the diaphragm stage number from the open position. The diaphragm accuracy before the read position is corrected is indicated by a dotted line 32, and the diaphragm accuracy after the read position is corrected is indicated by a solid line 33.

The diaphragm accuracy before the read position is corrected indicated by the dotted line 32 is the diaphragm accuracy where the driving is performed without correcting the read position for each zoom position 27 and corresponds to the error between the actual F-number and the target F-number 22 when the driving is performed with the value of the read position master 28. ΔFno0(ZP2) to ΔFno110(ZP2) when the sum of the read position master 28 and the read position correction amount 29 is +2 correspond to the diaphragm accuracy before the read position is corrected. When it is assumed that the maximum absolute value of the error amount at this time is a pre-correction error maximum value 34, the pre-correction error maximum value 34 corresponds to the maximum value of |ΔFno0(ZP2)| to |ΔFno110(ZP2)|. While the read position correction amount 29 is changed, the read position correction amount 29 that minimizes the maximum error value is calculated.

The diaphragm accuracy after the read position is corrected indicated by the solid line 33 indicates a value when the read position correction amount 29 is +1 at ZP2. In other words, it illustrates an error between the target value and the actual F-number when the sum of the read position master 28 and the read position correction amount 29 is +3. Then, a post-correction error maximum value 35 is smaller than the pre-correction error maximum value 34. Hence, the error between the target F-number 22 and the actual F-number can be reduced by correcting the read position master 28 using the read position correction amount 29. Thus, since the memory 11 stores the driving instruction value correction amount 24 and the read position correction amount 29, this embodiment reduces the error between the target F-number 22 and the actual F-number and controls the aperture amount with high accuracy.

Prior art need to store data of the position division number of the zoom lens unit 3×the division number of the driving instruction value of the diaphragm 4, in storing the relationship between the position of the zoom lens unit 3 and the driving instruction value of the diaphragm 4. For example, where the position division number of the zoom lens unit 3 is 50 and the division number of the driving instruction value of the diaphragm 4 is 110, it is necessary to store at least 50×110=5500 data. Therefore, the data capacity increases.

On the other hand, this embodiment separately stores the driving instruction value of the diaphragm 4 and the read position for each position of the zoom lens unit 3, and thus can reduce the data capacity. In this embodiment, for example, if the division number of the driving instruction value of the diaphragm 4 is 110, the driving instruction value memory 8 from the maximum opening to the minimum closing needs to store about 420×140×3 data. When the position division number of the zoom lens unit 3 is 50, the read position memory 9 may store 50×2 of about 100 data. In other words, this embodiment needs to store only a total of about 420+100=520 in comparison with the conventional data number of about 5500, and can reduce the data capacity.

In this embodiment, the memory 11 stores the driving instruction value master 23 and the read position master 28. Therefore, even if the measurement or adjustment such as the optical adjustment is performed before the measurements and storages of the driving instruction value correction amount 24 and the read position correction amount 29 of the diaphragm 4 are performed, the diaphragm 4 can be driven according to the design values (optical design values) of the driving instruction value master 23 and the read position master 28.

Although the measurement is performed by ZP1(TELE) in this embodiment, the measurement may be performed at any other zoom position 27 or a predetermined position. When the measurement is performed at a zoom position other than the zoom position that uses the maximum opening in the optical design, the diaphragm 4 is opened more widely than the optical design value, which may cause the flare. Thus, the measurement may be performed at the zoom position using the most open position in the optical design.

This embodiment performs the measurement for calculating the correction amount only at a single zoom position 27, but the correction amount may be calculated by performing the measurement at a plurality of zoom positions 27. Thereby, the focal length shift or the like can be corrected due to the zoom positions 27 at which the measurements have been performed. On the other hand, when the measurement is performed only at a single zoom position 27, the measurement time can be shorter than when the measurement is performed at a plurality of zoom positions 27.

This embodiment may reduce the data division number stored in each of the driving instruction value memory 8 and the read position memory 9. Thereby, the number of data to be stored can be reduced. In this case, when an F-number is designated between values stored as the target F-numbers 22 in the driving instruction value memory 8, the driving instruction value is calculated by linearly interpolating the sum of the driving instruction value master 23 and the driving instruction value correction amount 24. When the zoom lens unit 3 moves to the zoom position 27 between the values stored as the zoom positions 27 in the read position memory 9, the read position is calculated by linearly interpolating the sum of the read position master 28 and the read position correction amount 29.

This embodiment stores the respective data of the driving instruction value memory 8 and the read position memory 9 for each 1-2 phase drive stop position, but the present invention is not limited to this embodiment. For example, each data may be stored for each micro step stop position. In storing the data for each micro step stop position, the error between the target F-number 22 and the actual F-number can be made smaller than that where the data is stored for each 1-2 phase stop position.

In this case, the sum of the read position master 28 and the read position correction amount 29 for the zoom position 27 may not coincide with an end of the read position in the driving instruction value memory 8. For example, when the sum of the read position master 28 and the read position correction amount 29 at ZP 4 is +4.5, the index is at the middle position. In this case, the driving instruction value is calculated by linearly interpolating the sum of the driving instruction value master 23 and the driving instruction value correction amount 24 as described above.

### Second Embodiment

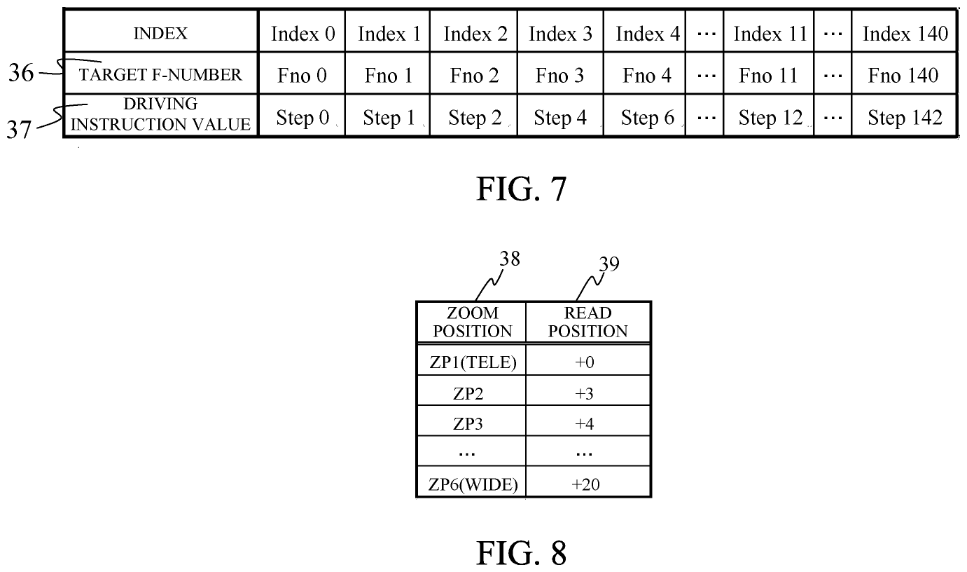

Referring now to FIGS. 7 and 8, a description will be given of a second embodiment according to the present invention. This embodiment is different from the first embodiment in type of data stored as the driving instruction value and the read position. FIG. 7 illustrates illustrative data stored in the drive command value memory 8 according to this embodiment. FIG. 8 illustrates illustrative data stored in the read position memory 9 according to this embodiment. FIGS. 7 and 8 correspond to FIGS. 2 and 4 according to the first embodiment, respectively.

According to the first embodiment, the driving instruction value memory 8 stores three types of data or the target F-number 22, the driving instruction value master 23, and the driving instruction value correction amount 24. On the other hand, in this embodiment, the driving instruction value memory 8 stores two types of data or a target F-number 36 and a driving instruction value 37. In other words, the driving instruction value memory 8 in this embodiment stores the driving instruction value 37 as driving instruction information.

According to the first embodiment, the read position memory 9 stores three kinds of data or the zoom position 27, the read position master 28, and the read position correction amount 29. On the other hand, in this embodiment, the read position memory 9 stores two types of data or a zoom position 38 and a read position 39. In other words, in this embodiment, the read position memory 9 stores the master and the correction amount in the first embodiment as one data (post-correction data) for each of the zoom position 38 and the read position 39.

This embodiment stores optical design values as the driving instruction value 37 and the read position 39 in the driving instruction value memory 8 and the read position memory 9 respectively until the actual F-number is measured. This corresponds to the master according to the first embodiment. Hence, even when the measurement and adjustment such as optical adjustment are performed before the actual F-number of the diaphragm 4 is measured and the correction amount is stored, the diaphragm 4 can be driven according to the optical design values of the zoom position 38 and the read position 39. After the measurement is performed similar to that in the first embodiment, the zoom position 38 and the read position 39 store a sum of the correction amounts calculated from the optical design value and the measurement value of the zoom position 38 and read position 39 stored before the measurement, respectively. Thereby, this embodiment can make the data capacity (data number) to be stored, smaller than that of the first embodiment.

### Third Embodiment

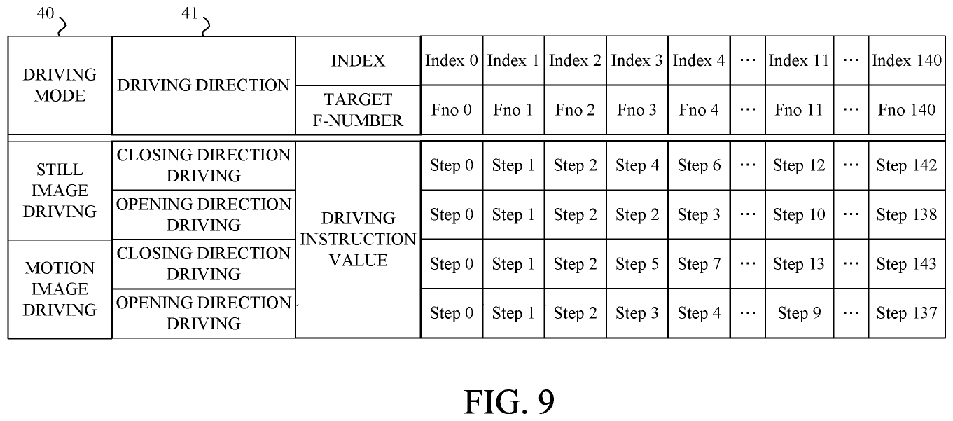

Referring now to FIGS. 9 to 12, a description will be given of a third embodiment according to the present invention. This embodiment differs from the first and second embodiments in that the driving instruction value and the read position are changed for each driving mode and for each driving direction.

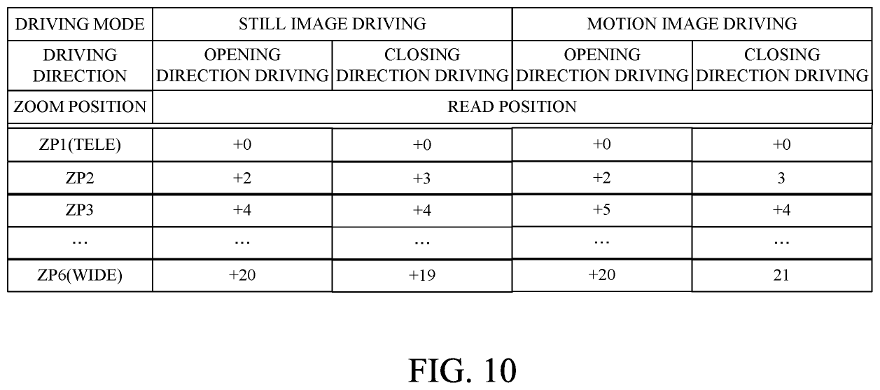

FIG. 9 illustrates illustrative data stored in the driving instruction value memory 8 according to this embodiment. FIG. 10 illustrates illustrative data stored in the read position memory 9 according to this embodiment. FIGS. 9 and 10 correspond to FIGS. 7 and 8 in the second embodiment, respectively.

In FIG. 9, a driving mode 40 has two types of image capturing modes: still image driving and motion image driving. In capturing a still image (in the still image driving mode), it is required to quickly drive the diaphragm 4 to the target F-number, so the high speed driving including the acceleration and deceleration is performed. On the other hand, in capturing a motion image (in the motion image driving mode), the quietness and smoothness are required, so the low speed driving is performed at a constant speed. Between the high speed driving and the low speed driving, even when the diaphragm 4 is controlled with the same driving instruction value, the diaphragm stops at positions with different aperture diameters of the blade due to the bouncing of the blade or the like. Hence, by controlling the diaphragm 4 using different driving instruction values for the two driving modes 40 of the still image driving and the motion image driving, an error between the target F-number and the actual F-number can be made smaller between the driving modes 40.

In FIG. 9, a driving direction 41 indicates two types of driving directions when the diaphragm 4 is driven in the closing direction and in the opening direction. The diaphragm 4 has mechanical rattles or plays such as an engagement play of the gear, a play between a cam pin of the blade and a cam groove of a rotary plate. Hence, if the driving direction of the diaphragm 4 is different, even if the diaphragm 4 is controlled with the same driving instruction value, the blades stop at different positions of the aperture diameter. Thus, by controlling the diaphragm 4 using different driving instruction values in the two driving directions 41 of the closing direction driving and the opening direction driving, an error between the target F-number and the actual F-number can be made smaller between the driving directions 41.

The error can be reduced between the target F-number and the actual F-number by storing data for each of the driving mode and the driving direction even in FIG. 10.

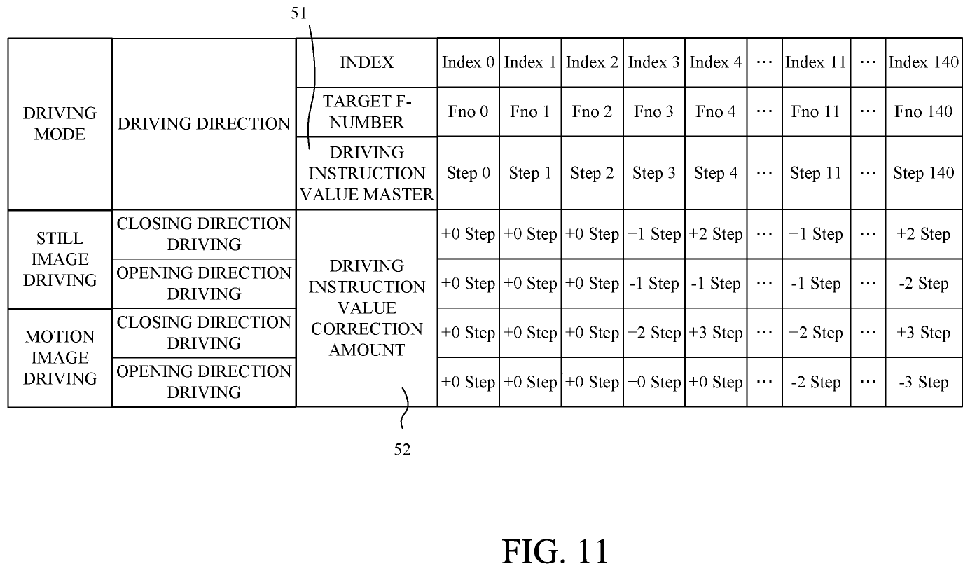

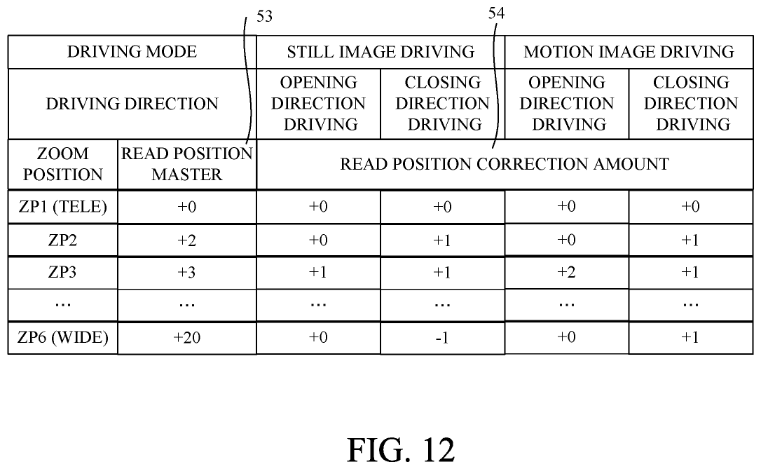

Referring now to FIGS. 11 and 12, a description will be given of a variation of this embodiment. FIG. 11 illustrates illustrative data stored in the drive command value memory 8 according to the variation of this embodiment. FIG. 12 illustrates illustrative data stored in the read position memory 9 according to the variation of this embodiment. FIGS. 11 and 12 correspond to FIGS. 2 and 4 in the first embodiment, respectively. As illustrated in FIGS. 11 and 12, a driving instruction value correction amount 52 and a read position correction amount 54 are changed for each driving mode and for each driving direction. A driving instruction value master 51 and a read position master 53 may be stored as a single master.

Thus, in each embodiment, the lens apparatus (the interchangeable lens 2) includes a controller (lens controller 7) that controls an aperture amount (aperture diameter) of the diaphragm 4 based on the position of the zoom lens unit 3. The controller selects part of data that indicates the relationship between the target F-number of the diaphragm and the driving instruction information when the zoom lens unit is located at a predetermined position, such as a telephoto end position or a wide-angle end position, based on the position of the zoom lens unit detected by the position detector. Then, the controller controls the aperture amount of the aperture using the selected part of the data.

The lens apparatus may include a memory 11 that stores data (for example, FIGS. 2, 7, 9, and 11) indicating the relationship between the target F-number of the diaphragm and the driving instruction information. Then, the controller controls the aperture amount of the diaphragm based on the position of the zoom lens unit, the read position of the driving instruction information stored in the memory, and the driving instruction information corresponding to the target F-number. The driving instruction information may include a first optical design value (such as the driving instruction value master 23) and a first correction amount (such as the driving instruction value correction amount 24) for determining a diaphragm driving instruction value. Alternatively, the driving instruction information may include a driving instruction value (such as the driving instruction value 37) of the diaphragm.

The memory may store driving instruction information for each diaphragm driving mode (capturing mode) (for example, FIGS. 9 and 11). The driving mode may include a still image driving mode and a motion image driving mode. The memory may store driving instruction information for each driving direction of the diaphragm (for example, FIGS. 9 and 11). The driving direction may include a closing direction and an opening direction.

The memory may store data (for example, FIGS. 4, 8, 10, and 12) for determining the part of the data. The data for determining the part of the data may be data indicating the relationship between the position of the zoom lens unit and the reference position information (read position information) of the part of the data. The reference position information may include a second optical design value (read position master 28) and a second correction amount (read position correction amount 29) for determining the reference position of the part of the data. Alternatively, the reference position information may be a reference position (read position 39) of the part of the data. The memory may store reference position information for each driving mode and for each driving direction of the diaphragm. The predetermined position may be a telephoto end position or a wide-angle end position. The lens apparatus may include a communicator (lens communicator 13) that receives information on a target F-number from the imaging apparatus (camera body 1). Then, the controller controls the aperture amount of the diaphragm based on the target F-number acquired via the communicator.

Each embodiment can provide a lens apparatus, an imaging apparatus, and an imaging system, each of which can accurately control the diaphragm with a small data capacity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-102836, filed on May 29, 2018 which is hereby incorporated by reference herein in its entirety.

What is claimed is:

1. A lens apparatus comprising:
an optical system including a zoom lens unit;
a diaphragm configured to adjust a light amount in the optical system;
a position detector configured to detect a position of the zoom lens unit; and
a controller configured to control an aperture amount of the diaphragm based on the position of the zoom lens unit,
wherein the controller selects, based on the position of the zoom lens unit detected by the position detector, part of data from data indicating a relationship between a target F-number of the diaphragm and driving instruction information when the zoom lens unit is located at a predetermined position, and controls the aperture amount of the diaphragm using the part of the data.

2. The lens apparatus according to claim 1, further comprising a memory configured to store the data indicating the relationship between the target F-number of the diaphragm and the driving instruction information when the zoom lens unit is located at a predetermined position,
wherein the controller controls the aperture amount of the diaphragm, based on the position of the zoom lens unit, the target F-number of a read position of the driving instruction information stored in the memory, and the driving instruction information corresponding to the target F-number.

3. The lens apparatus according to claim 2, wherein the driving instruction information includes a first optical design value and a first correction amount for determining a driving instruction value of the diaphragm.

4. The lens apparatus according to claim 2, wherein the driving instruction information includes a driving instruction value of the diaphragm.

5. The lens apparatus according to claim 2, wherein the memory stores the driving instruction information for each driving mode of the diaphragm.

6. The lens apparatus according to claim 5, wherein the driving mode includes a still image driving mode and a motion image driving mode.

7. The lens apparatus according to claim 2, wherein the memory stores the driving instruction information for each driving direction of the diaphragm.

8. The lens apparatus according to claim 7, wherein the driving direction includes a closing direction and an opening direction.

9. The lens apparatus according to claim 2, wherein the memory stores data for determining the part of the data.

10. The lens apparatus according to claim 9, wherein the data for determining the part of the data is data indicating a relationship between the position of the zoom lens unit and reference position information of a predetermined range.

11. The lens apparatus according to claim 10, wherein the reference position information includes a second optical design value and a second correction amount for determining a reference position of the part of the data.

12. The lens apparatus according to claim 10, wherein the reference position information is a reference position of the part of the data.

13. The lens apparatus according to claim 10, wherein the memory stores the reference position information for each driving mode of the diaphragm.

14. The lens apparatus according to claim 13, wherein the driving mode includes a still image driving mode and a motion image driving mode.

15. The lens apparatus according to claim 10, wherein the memory stores the reference position information for each driving direction of the diaphragm.

16. The lens apparatus according to claim 15, wherein the driving direction includes a closing direction and an opening direction.

17. The lens apparatus according to claim 1, wherein the predetermined position is a telephoto end position.

18. The lens apparatus according to claim 1, wherein the predetermined position is a wide-angle end position.

19. The lens apparatus according to claim 1, further comprising a communicator configured to receive information on the target F-number from an imaging apparatus,
wherein the controller controls the aperture amount of the diaphragm based on the target F-number.

20. An imaging apparatus to which a lens apparatus including a zoom lens unit and a diaphragm is detachably attached, the imaging apparatus comprising:
a communicator configured to transmit information on a target F-number of the diaphragm; and
a controller configured to control the communicator,
wherein the lens apparatus selects, based on a position of the zoom lens unit detected by a position detector, part of data from data indicating a relationship between a target F-number of the diaphragm and driving instruction information when the zoom lens unit is located at a predetermined position, and controls an aperture amount of the diaphragm using the part of the data.

21. An imaging system comprising:
a lens apparatus; and
an imaging apparatus including an image sensor configured to photoelectrically convert an optical image formed through the lens apparatus,
wherein a lens apparatus includes:
an optical system including a zoom lens unit;
a diaphragm configured to adjust a light amount in the optical system;
a position detector configured to detect a position of the zoom lens unit; and
a controller configured to control an aperture amount of the diaphragm based on the position of the zoom lens unit,
wherein the controller selects, based on the position of the zoom lens unit detected by the position detector, part of data from data indicating a relationship between a target F-number of the diaphragm and driving instruction information when the zoom lens unit is located at a predetermined position, and controls the aperture amount of the diaphragm using the part of the data.
